(19) United States
(12) Patent Application Publication
(10) Pub. No.: US 2025/0108934 A1
(43) Pub. Date: Apr. 3, 2025

(54) ANTI-COLLISION LIGHT FOR AIRCRAFT

(71) Applicants: Christian Nielsen, Palm Coast, FL (US); Jakub Gregor, Palm Coast, FL (US); Daniel Stenko, Kosice (SK)

(72) Inventors: Christian Nielsen, Palm Coast, FL (US); Jakub Gregor, Palm Coast, FL (US); Daniel Stenko, Kosice (SK)

(21) Appl. No.: 18/671,990

(22) Filed: May 23, 2024

Related U.S. Application Data
(60) Provisional application No. 63/587,309, filed on Oct. 2, 2023.

(51) Int. Cl. B64D 47/06

(52) U.S. Cl. CPC B64D 47/06; B64D 2203/00

(57) ABSTRACT

A drag-reducing anticollision light for aircraft that includes a base that has convex-shaped left and right sides. A light housing that has suitable LEDs is mounted to the base, wherein the light housing is multistoried. A PC cover of an aerodynamic shape covers the light housing, and an upper base secures the PC cover to the base. Compared to conventional anticollision lights in aircraft, the anticollision light offers significantly less drag, thus saving fuel costs.

### CROSS-REFERENCE TO RELATED APPLICATIONS

This application claims priority from a U.S. Provisional Patent Appl. Ser. No. 63/587,309, filed on Oct. 2, 2023, which is incorporated herein by reference in its entirety.

### FIELD OF INVENTION

The present invention relates to an anti-collision light for aircraft, and more particularly, the present invention relates to an anti-collision light with an aerodynamic design of extremely low parasitic drag and extremely low profile height.

### BACKGROUND

Anticollision lights, also known as Beacon lights or strobe lights play a critical role in aircraft. Anticollision lights are used to improve the visibility of the aircraft to others. This is important to minimize the risk of collision with the aircraft. Typically, the anticollision lights in aircraft include incandescent bulbs or LEDs. LEDs are replacing incandescent bulbs for a variety of reasons, including being light in weight, consuming less power, and being compact. However, LED anticollision lights are typically made in cylindrical shapes that offer significant drag and thereby increase aircraft fuel consumption. This is undesirable in terms of fuel efficiency and climate change issues.

An industrial need is therefore appreciated for improvements in the designs of anticollision lights.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an anticollision light that offers significantly less drag while far exceeding the certification minimums and the existing prior art for same.

Another object of the present invention is that the anticollision light includes LEDs of multiple wavelength LEDs, wherein some of which are built in double or quad chip custom form factors, and wherein is incorporated the technology to achieve greater optical efficiency and output in multiple wavelengths of aviation including white, red, green, and NVIS InfraRed of 850 nm and 1065 nm.

Still, another object of the present invention is that the anticollision light has an aerodynamic shape offering extremely low drag

In one aspect, disclosed is an anticollision light for an aircraft comprising a base that has convex-shaped left and right sides; a light housing mounted to the base, a plurality of lights disposed in the light housing; a PC cover of an aerodynamic shape covering the light housing; and an upper base configured to secure the PC cover to the base. The plurality of lights comprises multicolor light. The PC cover is convex shaped on the left, right, and top faces, wherein the PC cover is broad and roundish at the middle portion which narrows down to pointed front and rear ends for the aerodynamic shape. The light housing is multistory comprising a plurality of platforms, wherein the light of the plurality of lights is disposed on each platform. The plurality of lights are LEDs. The size of platforms decreases from bottom to top.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of the anticollision light, according to an exemplary embodiment of the present invention.

FIG. 2 shows an exploded view of the anticollision light, according to an exemplary embodiment of the present invention.

FIG. 3 shows another perspective view of the anticollision light, according to an exemplary embodiment of the present invention.

FIG. 4 is a simulation diagram showing the results of drag analysis of the anticollision light, according to an exemplary embodiment of the present invention.

FIG. 5 is a simulation diagram showing the results of drag analysis of a conventional anticollision light for comparison.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including” when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

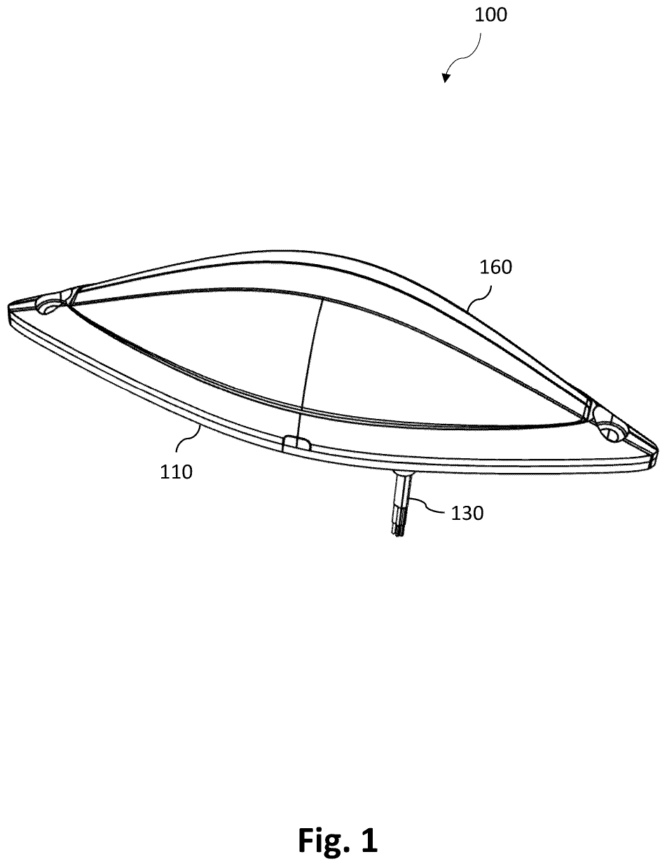

Disclosed is an anticollision light for aircraft that has an aerodynamic shape because of which the anticollision light offers significantly less drag compared to conventional anticollision lights. The shape of the anticollision light is shown in FIG. 1 which is aerodynamic, narrower in the front and rear, and curves outwards in the middle. The left and right sides are of convex shape. The top of the body is also convex shape wherein the middle portion is bulbous while the front and rear are pointed. The anti-collision light is of an elongated and narrow profile.

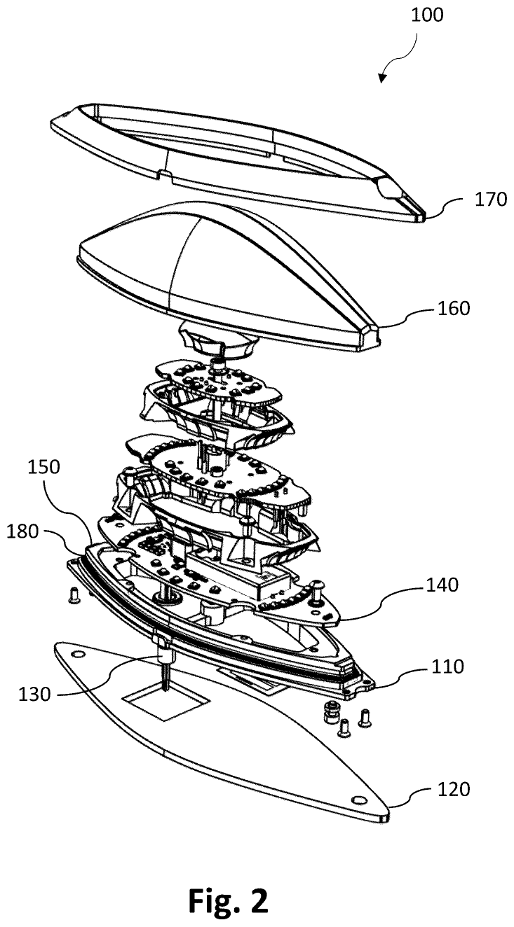

Referring to FIG. 2 which shows an exploded view of the drag-reducing anticollision light 100. The drag-reducing anticollision light 100 includes a base 110 that can be mounted to the body of the vehicle. The base provides a framework for the anticollision light to which different components can be mounted. The base 110, as shown in the drawing has convex sides that with flattened front and rear ends. A gasket 120 is sandwiched between the base and the vehicle body. A heat shrink tube 130 extends from the gasket and the wires can pass through this heatsink tube. The gasket can be made from silicon rubber material while the heat shrink tube can be made from crosslinked polyolefin. It is to be noted that the materials provided herein are only examples, and any suitable materials can be used without departing from the scope of the present invention. The base can be coupled to the body of the vehicle using suitable screws.

The Anticollision Light 100 includes an LED housing 140 which is multi-story. PCB boards and heat sinks can be encased or mounted to LED housing. FIG. 2 shows the LED housing having three platforms in which the upper platform is smaller in size than the platforms below it. On each platform are mounted multiple LEDs and on and in each platform these LEDs can be of multiple colors and wavelengths and mixed within the same level i.e., each platform can have multiple types of LEDs. The LED housing is typically of an elongated oval shape that can be mounted to the base. For example, screws can be used to mount the LED housing to the base. To secure the LED housing to the base, an O-ring 150 can be used. This may provide the desired sealing and grip to the LED housing. A PC cover 160 can then cover the LED housing, the PC cover can be made from transparent material. Any degree of translucency in the PC cover is within the scope of the present invention. For example, the PC cover can be made from polycarbonate or high strength optical glass. A top base 170 is used to secure the PC cover to the base 110. The top base can be made from any durable material and can be made from any weather-resistant material. Suitable sealing 180 can be used to sealably secure the top base to the base.

In certain implementations, LEDs of different colors can be used, such as Red, White, Infra Red, NVIS Green, or Blue. The LEDs may also support Infrared spectrum of light providing enhanced visibility in dark. Any combination of colors can be used and is within the scope of the present invention. For example, the anticollision light can work in any combination of colors on the three levels of output. So, it can be ALL-RED, ALL WHITE, or a combination of RED and WHITE in the same light, or also in what is known in the industry as dual mode, using RED+InfraRed or White+Infrared, or 3 levels consisting of white, red and infrared or even mixed on each level of the light.

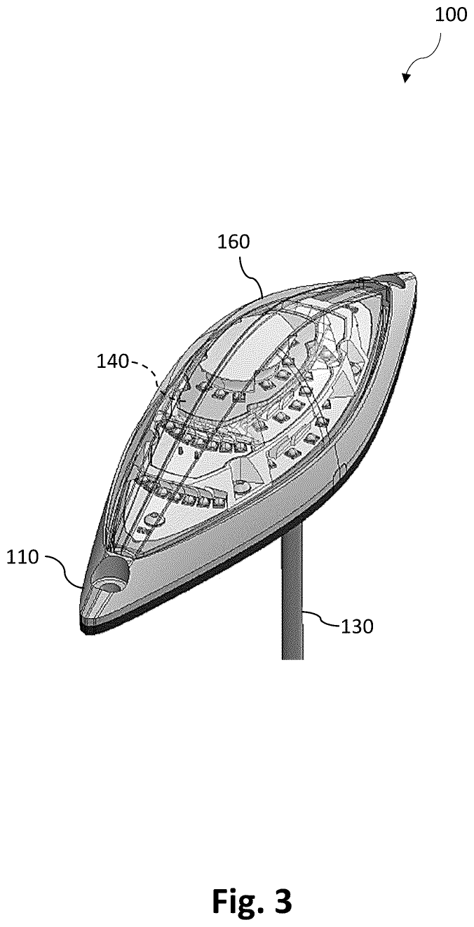

FIG. 3 shows another perspective view of the anticollision light showing the LEDs within the PC cover.

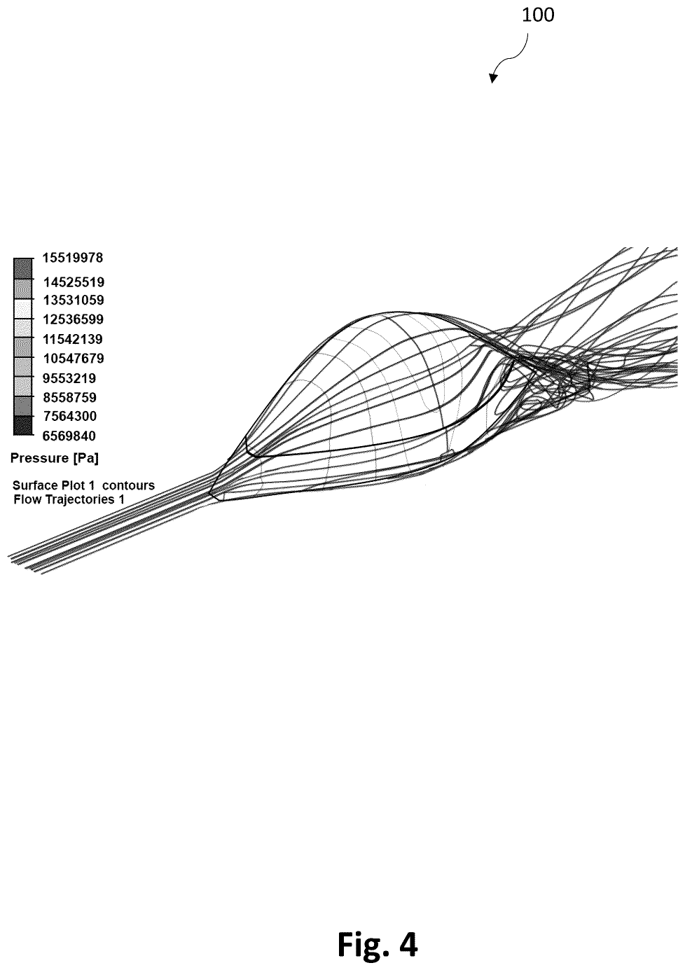

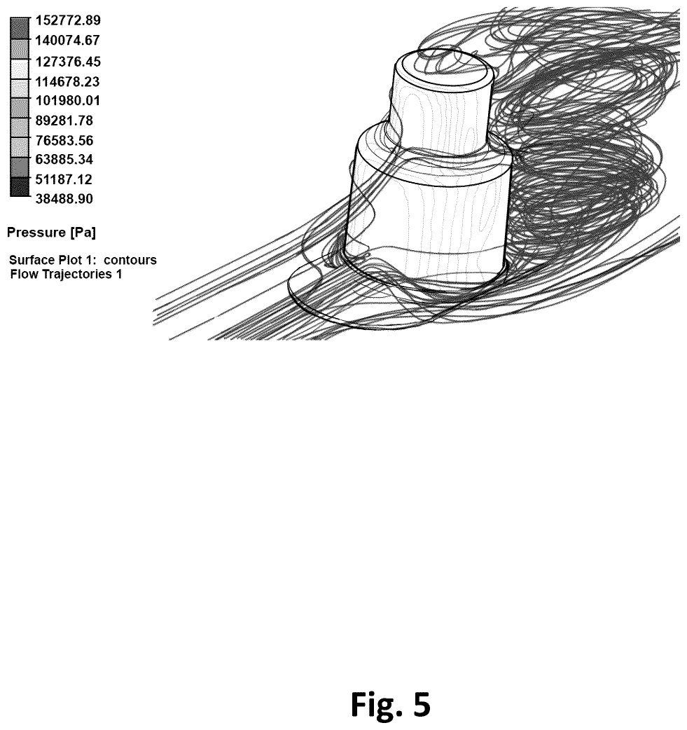

The disclosed anticollision light compared to conventional anticollision light helps to reduce the drag on the anticollision light, thus saving fuel costs. The drag analysis on the disclosed anticollision light (shown in FIG. 4) and a conventional anticollision light (shown in FIG. 5) were performed using a simulation experiment. In the experiment, the Flow simulation conditions were as follows: Airflow—600 mph, surrounding pressure—1 Atm, Air kinematic viscosity—by the program, Air temperature—20°. The solid simulation conditions are as follows Lineal static, solver: FFEPlus, material: screws, alloy steel, lamp body, AL 6060 and clear, as polycarbonate, boundary conditions: imported from fluid simulation.

As can be seen in FIGS. 4 and 5, the differences between the drag offered by the disclosed drag-reducing anti-collision light and a conventional anti-collision light. It was observed that the disclosed anti-collision light offered a drag of about 78 Newtons in comparison to the 434 Newtons of drag experienced by the convention C-5 anti-collision light. The pressure field and streamlines show the amount of turbulence and pressure.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. An anti-collision light for an aircraft comprising:
a base that has convex-shaped left and right sides;
a light housing mounted to the base, a plurality of lights disposed in the light housing;
a PC cover of an aerodynamic shape covering the light housing; and
an upper base configured to secure the PC cover to the base, wherein an outer periphery of the upper base juxtaposes to an outer periphery of the base, and the upper base has a central hole for the PC cover to pass through.

2. The anti-collision light according to claim 1, wherein the plurality of lights comprise multicolor lights.

3. The anti-collision light according to claim 1, wherein the PC cover is convex shaped on left, right, and top faces thereof, wherein the PC cover is broad and roundish at a middle portion thereof, which narrows down to pointed front and rear ends for the aerodynamic shape.

4. The anti-collision light according to claim 1, wherein the light housing is of an elongated oval shape mounted to the base, wherein the light housing is multistory comprising a three spaced apart platforms arranged vertically one above another, wherein lights of the plurality of lights are disposed on each platform.

5. The anti-collision light of claim 4, wherein the plurality of lights are LEDs, wherein the plurality of lights comprises lights of different wavelengths.

6. The anti-collision light of claim 4, wherein a size of each platform decreases from bottom to top.

7. The anti-Collison light of claim 2, wherein the plurality of lights are configured to operate in all red, all white, and a combination of red and white colors.

8. The anti-Collison light of claim 2, wherein the plurality of lights are configured to operate as dual mode in red+infrared lights.

9. The anti-Collison light of claim 2, wherein the plurality of lights are configured to operate as dual mode in white+infrared lights.
